(19) United States
(12) Patent Application Publication
(10) Pub. No.: US 2007/0060704 A1
(43) Pub. Date: Mar. 15, 2007

(54) Light-scattering moldings with high light transmission

(76) Inventors: Claus Rudiger, Krefeld (DE); Klaus Kraner, Solingen (DE); Jurgen Rohner, Koln (DE); Tanja Gruter-Reetz, Krefeld (DE); Fumika Kaneko, Tokyo (JP)

Correspondence Address: BAYER MATERIAL SCIENCE LLC, 100 BAYER ROAD, PITTSBURGH, PA, 15205, US

(21) Appl. No.: 11/504,927

(22) Filed: Aug. 16, 2006

(30) Foreign Application Priority Data
Aug. 20, 2005 (DE) 102005039413.2

(51) Int. Cl. C08L 51/00

(52) U.S. Cl. 525/67

(57) ABSTRACT

A solid sheet comprising 80 to 99.99 wt. % of a transparent polycarbonate having weight average molecular weight of 15,000 to 21,000 g/mol, specifically excluding 18,000 g/mol, and 0.01 to 20 wt. % of transparent polymeric particles having an optical density which differs from that of the polycarbonate is disclosed. The sheet is particularly suitable as a diffuser in flat screens.

### FIELD OF THE INVENTION

The invention is directed to a molded article of manufacture and in particular to a transparent article containing polycarbonate.

### BACKGROUND OF THE INVENTION

The use of diffuser sheets in so-called backlight units (BLUs) for flat screens requires this system to have a very high luminance, so that the brightness of the image on the flat screen is as great as possible. In principle, a backlight unit (direct light system) has the construction described below. It generally consists of a housing in which, depending on the size of the backlight unit, a varying number of fluorescent tubes, known as CCFL (cold cathode fluorescent lamps), are arranged. The inside of the housing has a light-reflective coating. The diffuser sheet, which has a thickness of 1 to 3 mm, preferably a thickness of 2 mm, lies on top of this coating system. On top of the diffuser sheet is a set of films, which may have the following functions: light scattering (diffuser films), circular polarization, focusing of the light in a forward direction by means of so-called BEF (brightness enhancing film), and linear polarization. The linear polarizing film lies directly beneath the LCD display on top.

Light-scattering translucent products made from polycarbonate with various light-scattering additives and molded parts produced therefrom are already known from the prior art.

Thus EP-A 634 445, for examples, discloses light-scattering compositions which contain polymeric particles based on vinyl acrylate with a core/shell morphology in combination with TiO₂.

The use of light-scattering polycarbonate films in flat screens is described in US 2004/0066645. Polyacrylates, PMMA, polytetrafluoroethylenes, polyalkyl trialkoxysiloxanes and mixtures of these components are cited as particulate light diffusing component.

JP 03078701 describes light-scattering PC sheets having calcium carbonate and titanium dioxide as scattering pigments and a light transmission of approximately 40%.

JP 05257002 describes light-scattering PC sheets having scattering pigments consisting of silica.

JP 10046022 describes PC sheets having scattering pigments consisting of polyorganosiloxanes.

JP 2004/029091 describes PC diffuser sheets which contain 0.3 to 20% of scattering pigment and 0.0005 to 0.1% of optical brightener.

The molecular weight of the polycarbonate is generally not further specified in these documents, however.

JP 10046018 describes a PC sheet which contains 0.01 to 1% of cross-linked spherical polyacrylates.

In order to assess the suitability of the light-scattering sheets for so-called backlight units for LCD flat screens, the brightness of the overall system, in other words of the entire BLU, not just of the diffuser sheets themselves, must be considered in particular. The diffuser sheets known from the prior art have an unsatisfactory color uniformity combined with high brightness.

### SUMMARY OF THE INVENTION

A solid sheet comprising 80 to 99.99 wt. % of a transparent polycarbonate having weight average molecular weight of 15,000 to 21,000 g/mol, specifically excluding 18,000 g/mol, and 0.01 to 20 wt. % of transparent polymeric particles having an optical density which differs from that of the polycarbonate is disclosed. The sheet is particularly suitable as a diffuser in flat screens.

### DETAILED DESCRIPTION OF THE INVENTION

In this invention it has been found that the viscosity of the polycarbonate base resin that is used has a critical influence on the performance of the diffuser sheets. Surprisingly, when used as a diffuser sheet, polycarbonate resins having a low viscosity (low molecular weight) exhibit a markedly higher luminance than polycarbonate resins having a higher viscosity (higher molecular weight), even though the optical properties of the base resins used in the examples are the same in terms of light transmission of the base resin. Polycarbonate resins having a molecular weight of Mw=16,000 to 21,000 g/mol or an MFR=50 to 80 cm3/10 min.; 300° C.; 1.2 kg) have proved to be particularly favorable in this connection.

The present invention thus firstly provides a solid sheet containing a composition comprising
80 to 99.99 wt. % of a transparent polycarbonate having a weight average molecular weight of M_{w} 15,000 to 21,000 g/mol, preferably 15,000 to 21,000 with the exception of 18,000, particularly preferably 18,100 to 21,000, most particularly preferably 18,500 to 20,000 g/mol, or an MFR of 50 to 80 cm³/(10 min) (300° C.; 1.2 kg) and 0.01 to 20 wt. % of transparent polymeric particles having an optical density which differs from that of the polycarbonate.

The solid sheets according to the invention exhibit a high light transmission combined with high light scattering and may be used for example in the lighting systems for flat screens (LCD screens). High light scattering combined with high light transmission is of decisive importance here. The lighting system for such flat screens may be achieved either with lateral light injection (edgelight system) or, for larger screen sizes, for which lateral light injection is no longer sufficient, by means of a backlight unit (BLU), in which the direct illumination behind the diffuser sheet must be distributed by this as uniformly as possible (direct light system).

Furthermore, the inventive (optionally multilayer) solid sheet is characterized by a high color uniformity over an extended period combined with undiminished luminance (brightness) during operation of the flat screens.

This invention also provides the use of the solid sheets according to the invention as diffuser sheets for flat screens, in particular in the backlighting of LCD displays.

Suitable polycarbonates for the production of the solid sheets according to the invention are all known polycarbonates. These are homopolycarbonates, copolycarbonates and thermoplastic polyester carbonates.

The suitable polycarbonates have average molecular weights M̅_{w} of 15,000 to 21,000, determined by measuring the relative solution viscosity in dichloromethane or in mixtures of equal amounts by weight of phenol/o-dichlorobenzene calibrated by light scattering. The average molecular weight is preferably 15,000 to 21,000 with the exception of 18,000, particularly preferably 18,100 to 21,000, most particularly preferably 18,500 to 20,000.

With regard to the manufacture of polycarbonates, reference is made by way of example to “Schnell, Chemistry and Physics of Polycarbonates, Polymer Reviews, Vol. 9, Interscience Publishers, New York, London, Sydney 1964”, and to “D.C. PREVORSEK, B. T. DEBONA and Y. KESTEN, Corporate Research Center, Allied Chemical Corporation, Moristown, N.J. 07960, ‘Synthesis of Poly(ester)carbonate Copolymers’ in Journal of Polymer Science, Polymer Chemistry Edition, Vol. 19, 75-90 (1980)”, and to “D. Freitag, U. Grigo, P. R. Müller, N. Nouvertne, BAYER AG, ‘Polycarbonates’ in Encyclopedia of Polymer Science and Engineering, Vol. 11, Second Edition, 1988, pages 648-718” and finally to “Drs U. Grigo, K. Kircher and P. R. Müller ‘Polycarbonate’ in Becker/Braun, Kunststoff-Handbuch, Volume 3/1, Polycarbonate, Polyacetale, Polyester, Celluloseester, Carl Hanser Verlag Munich, Vienna 1992, pages 117-299”.

Production of the polycarbonates is preferably performed by the interfacial polycondensation process or the melt interesterification process and is described below using the interfacial polycondensation process by way of example. The compounds preferably used as starting compounds are bisphenols having the general formula
HO—Z—OH
wherein
Z is a divalent organic radical having 6 to 30 carbon atoms and containing one or more aromatic groups.

Examples of such compounds are bisphenols belonging to the group of dihydroxydiphenyls, bis(hydroxyphenyl) alkanes, indane bisphenols, bis(hydroxyphenyl) ethers, bis(hydroxyphenyl) sulfones, bis(hydroxyphenyl) ketones and α,α′-bis(hydroxyphenyl) diisopropyl benzenes.

Particularly preferred bisphenols belonging to the previously cited groups of compounds are bisphenol A, tetraalkyl bisphenol A, 4,4-(meta-phenylene diisopropyl) diphenol (bisphenol M), 4,4-(para-phenylene diisopropyl) diphenol, 1,1-bis-(4-hydroxyphenyl)-3,3,5-trimethyl cyclohexane (bisphenol TMC) and mixtures thereof.

The bisphenol compounds for use according to the invention are preferably reacted with carbonic acid compounds, in particular phosgene, or in the case of the melt interesterification process with diphenyl carbonate or dimethyl carbonate.

Polyester carbonates are preferably obtained by reacting the previously cited bisphenols, at least one aromatic dicarboxylic acid and optionally carbonic acid equivalents. Suitable aromatic dicarboxylic acids are for example phthalic acid, terephthalic acid, isophthalic acid, 3,3′- or 4,4′-diphenyldicarboxylic acid and benzophenone dicarboxylic acids. A part, up to 80 mol %, preferably from 20 to 50 mol %, of the carbonate groups in the polycarbonates may be replaced by aromatic dicarboxylic acid ester groups.

Examples of inert organic solvents used in the interfacial polycondensation process are dichloromethane, the various dichloroethanes and chloropropane compounds, tetrachloromethane, trichloromethane, chlorobenzene and chlorotoluene, chlorobenzene or dichloromethane or mixtures of dichloromethane and chlorobenzene preferably being used.

The interfacial polycondensation reaction may be accelerated by catalysts such as tertiary amines, in particular N-alkyl piperidines or onium salts. Tributylamine, triethylamine and N-ethyl piperidine are preferably used. In the melt interesterification process the catalysts cited in DE-A 42 38 123 are preferably used.

The polycarbonates may be deliberately branched in a controlled manner by the use of small quantities of branching agents. Some suitable branching agents are: phloroglucinol, 4,6-dimethyl-2,4,6-tri-(4-hydroxyphenyl) heptene-2; 4,6-dimethyl-2,4,6-tri-(4-hydroxyphenyl) heptane; 1,3,5-tri-(4-hydroxyphenyl) benzene; 1,1,1-tri-(4-hydroxyphenyl) ethane; tri-(4-hydroxyphenyl) phenyl methane; 2,2-bis-[4,4-bis-(4-hydroxyphenyl) cyclohexyl] propane; 2,4-bis-(4-hydroxyphenyl isopropyl) phenol; 2,6-bis-(2-hydroxy-5′-methylbenzyl)-4-methylphenol; 2-(4-hydroxyphenyl)-2-(2,4-dihydroxyphenyl) propane; hexa-(4-(4-hydroxyphenyl isopropyl) phenyl) orthoterephthalic acid ester; tetra-(4-hydroxyphenyl) methane; tetra-(4-(4-hydroxyphenyl isopropyl) phenoxy) methane; α,α′,α″-tris-(4-hydroxyphenyl)-1,3,5-triisopropyl benzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxy-triphenyl)methyl) benzene and in particular: 1,1,1-tri-(4-hydroxyphenyl) ethane and bis-(3-methyl-4-hydroxyphenyl)-2-oxo-2,3-dihydroindole.

The 0.05 to 2 mol % of branching agents or mixtures of branching agents that may optionally be incorporated, based on diphenols used, may be added together with the diphenols but may also be added at a later stage of the synthesis.

Phenols such as phenol, alkyl phenols such as cresol and 4-tert-butyl phenol, chlorophenol, bromophenol, cumyl phenol or mixtures thereof are preferably used as chain terminators, in quantities of 1-20 mol %, preferably 2-10 mol %, per mol of bisphenol. Phenol, 4-tert-butyl phenol or cumyl phenol are preferred.

Chain terminators and branching agents may be added to the syntheses either separately or together with the bisphenol.

The production of polycarbonates by the melt interesterification process is described in DE-A 42 38 123 by way of example.

Preferred polycarbonates according to the invention are the homopolycarbonate based on bisphenol A, the homopolycarbonate based on 1,1-bis-(4-hydroxy-phenyl)-3,3,5-trimethyl cyclohexane and the copolycarbonates based on the two monomers bisphenol A and 1,1-bis-(4-hydroxyphenyl)-3,3,5-trimethyl cyclohexane and the copolycarbonates based on the two monomers bisphenol A and 4,4′-dihydroxydiphenyl (DOD).

The homopolycarbonate based on bisphenol A is particularly preferred.

Suitable transparent polymeric particles having an optical density differing from that of the polycarbonate are for example those based on acrylate having a core-shell morphology, preferably as disclosed in EP-A 634 445.

These polymeric particles have a core consisting of a rubber-like vinyl polymer. The rubber-like vinyl polymer may be a homopolymer or copolymer of any of the monomers which have at least one ethylene-unsaturated group and which to the person skilled in the art in the field, as is known, suggest addition polymerization under the conditions of emulsion polymerization in an aqueous medium. Such monomers are listed in US 4 226 752, column 3, lines 40-62.

The rubber-like vinyl polymer preferably contains at least 15%, more preferably at least 25%, most preferably at least 40% of a polymerized acrylate, methacrylate, monovinyl arene or optionally substituted butadiene and from 0 to 85%, more preferably 0 to 75%, most preferably 0 to 60% of one or more copolymerised vinyl monomers, based on the total weight of the rubber-like vinyl polymer.

Preferred acrylates and methacrylates are alkyl acrylates or alkyl methacrylates, which preferably contain 1 to 18, particularly preferably 1 to 8, most preferably 2 to 8 carbon atoms in the alkyl group, such as methyl, ethyl, n-propyl, isopropyl, n-butyl, sec-butyl or tert-butyl or hexyl, heptyl or octyl groups. The alkyl group may be branched or linear. The preferred alkyl acrylates are ethyl acrylate, n-butyl acrylate, isobutyl acrylate or 2-ethylhexyl acrylate. The most preferred alkyl acrylate is butyl acrylate.

Other suitable acrylates are, for example, 1,6-hexanediol diacrylate, ethyl thioethyl methacrylate, isobomyl acrylate, 2-hydroxyethyl acrylate, 2-phenoxyethyl acrylate, glycidyl acrylate, neopentyl glycol diacrylate, 2-ethoxyethyl acrylate, t-butyl aminoethyl methacrylate, 2-methoxyethyl acrylate, glycidyl methacrylate or benzyl methacrylate.

Preferred monovinyl arenes are styrene or a-methyl styrene, optionally substituted at the aromatic ring with an alkyl group, such as methyl, ethyl or tertiary butyl, or with a halogen, such as chlorostyrene.

If substituted, the butadiene is preferably substituted with one or more alkyl groups containing 1 to 6 carbon atoms, or with one or more halogens, most preferably with one or more methyl groups and/or one or more chlorine atoms. Preferred butadienes are 1,3-butadiene, isoprene, chlorobutadiene or 2,3-dimethyl-1,3-butadiene.

The rubber-like vinyl polymers may contain one or more (co)polymerized acrylates, methacrylates, monovinyl arenes and/or optionally substituted butadienes. These monomers may be copolymerized with one or more other copolymerizable vinyl polymers, such as diacetone acrylamide, vinyl naphthalene, 4-vinyl benzyl alcohol, vinyl benzoate, vinyl propionate, vinyl caproate, vinyl chloride, vinyl oleate, dimethyl maleate, maleic anhydride, dimethyl fumarate, vinyl sulfonic acid, vinyl sulfonamide, methylvinyl sulfonate, N-vinyl pyrrolidone, vinyl pyridine, divinyl benzene, vinyl acetate, vinyl versatate, acrylic acid, methacrylic acid, N-methyl methacrylamide, acrylonitrile, methacrylonitrile, acrylamide or N-(isobutoxymethyl) acrylamide.

One or more of the aforementioned monomers are optionally reacted with 0 to 10%, preferably with 0 to 5%, of a copolymerizable, polyfinctional crosslinker and/or with 0 to 10%, preferably with 0 to 5%, of a copolymerizable polyfunctional grafting agent, based on the total weight of the core. If a crosslinking monomer is used, it is preferably used in a content of 0.05 to 5%, more preferably 0.1 to 1%, based on the total weight of the core monomers. Crosslinking monomers are well known in the field and generally have a polyethylene-type unsaturation, in which the ethylene-unsaturated groups have roughly the same reactivity, such as divinyl benzene, trivinyl benzene, 1,3- or 1,4-triol acrylates or methacrylates, glycol di- or trimethacrylates or acrylates, such as ethylene glycol dimethacrylate or diacrylate, propylene glycol dimethacrylate or diacrylate, 1,3- or 1,4-butylene glycol dimethacrylate or, most preferably, 1,3- or 1,4-butylene glycol diacrylate. If a grafting agent monomer is used, it is preferably used in a content of 0.1 to 5%, more preferably 0.5 to 2.5%, based on the total weight of the core monomers. Grafting agent monomers are well known in the field and are generally polyethylene-unsaturated monomers with adequately low reactivity of the unsaturated groups, such that significant lasting unsaturation is possible, which remains in the core following its polymerisation. Preferred grafting agents are copolymerizable allyl, methallyl or crotyl esters of α,β-ethylene-unsaturated carboxylic acids or dicarboxylic acids, such as allyl methacrylate, diallyl maleate and allyl acryloxypropionate, most preferably allyl methacrylate.

The polymeric particles most preferably contain a core of rubber-like alkyl acrylate polymer, wherein the alkyl group has 2 to 8 carbon atoms, optionally copolymerised with 0 to 5% crosslinker and 0 to 5% grafting agent, based on the total weight of the core. The rubber-like alkyl acrylate is preferably copolymerized with up to 50% of one or more copolymerizable vinyl monomers, for example those previously cited. Suitable crosslinking and grafting agent monomers are well known to the person skilled in the art in the field, and they are preferably those such as are described in EP-A 0 269 324.

The core of the polymeric particles may contain residual oligomeric material, which was used in the polymerization process to swell the polymer particles; however, such an oligomeric material has an adequate molecular weight to prevent its diffusion or to prevent it from being extracted during processing or use. The polymeric particles contain one or more shells. These one or more shells are preferably produced from a vinyl homopolymer or copolymer. Suitable monomers for producing the shell(s) are listed in U.S. Pat. No. 4,226,752, column 4, lines 20-46, reference being made to the details thereof. One or more shells are preferably a polymer consisting of a methacrylate, acrylate, vinyl arene, vinyl carboxylate, acrylic acid and/or methacrylic acid.

Preferred acrylates and methacrylates are alkyl acrylates or alkyl methacrylates, which preferably contain 1 to 18, more preferably 1 to 8, most preferably 2 to 8 carbon atoms in the alkyl group, such as methyl, ethyl, n-propyl, isopropyl, n-butyl, isobutyl or tert-butyl, 2-ethylhexyl or the hexyl, heptyl or octyl groups. The alkyl group may be branched or linear. The preferred alkyl acrylate is ethyl acrylate. Other acrylates and methacrylates which may be used are those previously cited for the core, preferably 3-hydroxypropyl methacrylate. The most preferred alkyl methacrylate is methyl methacrylate.

Preferred vinyl arenes are styrene or a-methyl styrene, optionally substituted at the aromatic ring with an alkyl group, such as methyl, ethyl or tert-butyl, or with a halogen such as chlorostyrene.

A preferred vinyl carboxylate is vinyl acetate.

The shell(s) preferably contain(s) at least 15%, more preferably at least 25%, most preferably at least 40% of a polymerised methacrylate, acrylate or monovinyl arene and 0 to 85%, more preferably 0 to 75%, most preferably 0 to 60% of one or more vinyl comonomers, such as other alkyl methacrylates, aryl methacrylates, alkyl acrylates, aryl acrylates, alkyl and aryl acrylamides, acrylonitrile, methacrylonitrile, maleinimide and/or alkyl and aryl acrylates and methacrylates, which are substituted with one or more substituents, such as halogen, alkoxy, alkylthio, cyanoalkyl or amino.

Examples of suitable vinyl comonomers have been previously cited. Two or more monomers may be copolymerised.

The shell polymer may contain a crosslinker and/or a grafting agent of the type previously cited with reference to the core polymer.

The shell polymers preferably make up 5 to 40%, more preferably 15 to 35%, of the total particle weight.

The polymeric particles contain at least 15%, preferably 20 to 80%, more preferably 25 to 60%, most preferably 30 to 50% of a polymerized alkyl acrylate or methacrylate, based on the total weight of the polymer. Preferred alkyl acrylates and methacrylates have been previously cited. The alkyl acrylate or alkyl methacrylate component may be present in the core and/or in the shell(s) of the polymeric particles. Homopolymers of an alkyl acrylate or methacrylate in the core and/or the shell(s) may be used, but an alkyl (meth)acrylate is preferably copolymerised with one or more other types of alkyl (meth)acrylates and/or one or more other vinyl polymers, preferably with those listed above. The polymeric particles most preferably contain a core consisting of a poly(butyl) acrylate and one or more shells consisting of poly(methyl methacrylate).

The polymeric particles are useful for imparting light scattering properties to the polycarbonate. The refractive index n of the core and of the shell(s) of the polymeric particles is preferably within +/−0.25 units, more preferably within +/−0.18 units, most preferably within +/−0.12 units of the refractive index of the polycarbonate. The refractive index n of the core and of the shell(s) is preferably no closer than +/−0.03 units, more preferably no closer than +/−0.01 units, most preferably no closer than +/−0.05 units to the refractive index of the polycarbonate. The refractive index is measured in accordance with the standard ASTM D 542-50 and/or DIN 53 400.

The polymeric particles generally have an average particle diameter of at least 0.5 micrometres, preferably at least 2 micrometres, more preferably 2 to 5 micrometres, most preferably 2 to 15 micrometres. “Average particle diameter” is understood to be the number average. Preferably at least 90%, most preferably at least 95%, of the polymeric particles have a diameter of more than 2 micrometres. The polymeric particles are preferably a free-flowing powder.

The polymeric particles may be produced in a known manner. Generally at least one monomer component of the core polymer is subjected to emulsion polymerization to form emulsion polymer particles. The emulsion polymer particles are swollen with the same or with one or more different monomer components of the core polymer, and the monomer(s) are polymerized within the emulsion polymer particles. The swelling and polymerization steps may be repeated until the particles have grown to the desired core size. The core polymer particles are suspended in a second aqueous monomer emulsion and a polymer shell is polymerized from the monomer(s) onto the polymer particles in the second emulsion. One or more shells may be polymerized on the core polymer. The production of core/shell polymer particles is described in EP-A 0 269 324 and in U.S. Pat. Nos. 3,793,402 and 3,808,108.

Surprisingly it has also been found that the brightness values may be further increased by the use of a small amount of optical brighteners.

Compounds of the following classes may be used as optical brighteners:
a) Bisbenzoxazoles having the following structure: 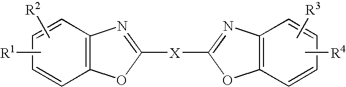
   wherein R¹, R², R⁵ and R⁶ mutually independently denote H, alkyl, aryl, heteroaryl or halogen and X denotes any of the following groups:
   Stilbene: 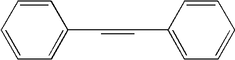
   Thiophene: 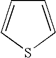
   Naphthalene: 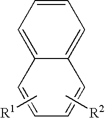
      where R¹ and R² mutually independently denote H, alkyl, aryl, heteroaryl or halogen.
   For example Uvitex® OB from Ciba Spezialitätenchemie with the formula 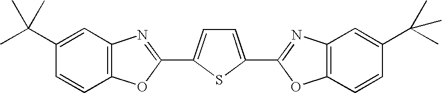
   or Hostalux KCB from Clariant GmbH with the formula 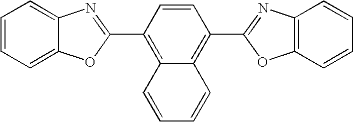
b) Phenylcoumarins having the following structure: 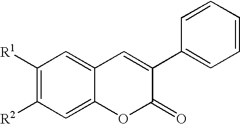
c) wherein R¹ and R² may mutually independently stand for H, alkyl, aryl, heteroaryl or halogen.

For example Leukopur® EGM from Clariant GmbH with the formula: 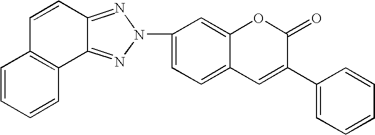
d) Bis-styryl biphenyls having the following structure: 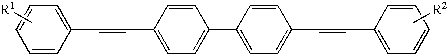
   wherein R¹ and R² may mutually independently stand for H, alkyl, aryl, heteroaryl or halogen.

A preferred embodiment of the invention is therefore a solid sheet which additionally contains 0.001 to 0.2 wt. %, preferably around 1000 ppm, of an optical brightener from the class of bisbenzoxazoles, phenylcoumarins or bis-styryl biphenyls. A particularly preferred optical brightener is Uvitex OB, from Ciba Spezialitätenchemie.

The solid sheets according to the invention may be produced either by injection molding or by extrusion. For technical reasons, if they are large-format solid sheets they cannot be produced cost-effectively by injection molding. In these cases extrusion is preferred. For extrusion, polycarbonate granules are fed to the extruder and melted in the extruder's plasticisation system. The plastic melt is pushed through a slit die, causing it to be shaped, given its desired fmal shape in the nip of a smoothing calender and fixed in shape by alternate cooling on smoothing rolls and in ambient air. The polycarbonates having a high melt viscosity used for extrusion are conventionally processed at melt temperatures of 230 to 320° C., the cylinder temperatures of the plasticising cylinder and the die temperatures being adjusted accordingly.

The solid sheet according to the invention may additionally have one or more layers produced by coextrusion (coextruded layers). Using one or more ancillary extruders and suitable melt adapters ahead of the slit die, polycarbonate melts of differing composition may be laid on top of one another to produce multilayer solid sheets (see for example EP-A 0 110 221 and EP-A 0 110 238).

Both the base layer and the optionally present coextruded layer(s) of the solid sheet according to the invention may additionally contain additives such as e.g. UV absorbers and other conventional processing aids, in particular release agents and flow control agents, as well as the conventional stabilizers for polycarbonates, in particular heat stabilizsers and antistatics, optical brighteners. Different additives or concentrations of additives may be present in each layer. The coextruded layer may contain UV absorbers and release agents in particular.

In a preferred embodiment the composition of the solid sheet additionally contains 0 to 0.5 wt. % of a UV absorber from the classes of benzotriazole derivatives, dimeric benzotriazole derivatives, triazine derivatives, dimeric triazine derivatives, diaryl cyanoacrylates.

The UV protection layer preferably consists of at least one coextruded layer having at least one UV absorber in a proportion of 0.1 to 20 wt. %, based on the coextruded layer.

The solid sheet according to the invention preferably has a thickness of 0.1 to 4.0 mm, particularly preferably 1.0 to 2.0 mm, in particular about 2 mm.

Coextruded layers which are optionally present preferably have a thickness of 10 to 100 μm, particularly preferably 20 to 60 μm.

Suitable stabilizers are, for example, phosphines, phosphites or Si-containing stabilizers and other compounds described in EP-A 0 500 496. Triphenyl phosphites, diphenyl alkyl phosphites, phenyl dialkyl phosphites, tris(nonylphenyl) phosphite, tetrakis-(2,4-di-tert-butylphenyl)-4,4′-biphenylene diphosphonite, bis-(2,4-dicumylphenyl) pentaerythritol diphosphite and triaryl phosphite may be cited by way of example. Triphenyl phosphine and tris-(2,4-di-tert-butylphenyl) phosphite are particularly preferred.

Suitable release agents are, for example, the esters or partial esters of monohydric to hexahydric alcohols, in particular of glycerol, pentaerythritol or guerbet alcohols.

Monohydric alcohols are for example stearyl alcohol, palmityl alcohol and guerbet alcohols, an example of a dihydric alcohol is glycol, an example of a trihydric alcohol is glycerol, examples of tetrahydric alcohols are pentaerythritol and mesoerythritol, examples of pentahydric alcohols are arabitol, ribitol and xylitol, examples of hexahydric alcohols are mannitol, glucitol (sorbitol) and dulcitol.

The esters are preferably the monoesters, diesters, triesters, tetraesters, pentaesters and hexaesters or mixtures thereof, in particular random mixtures, of saturated, aliphatic C₁₀ to C₃₆ monocarboxylic acids and optionally hydroxy monocarboxylic acids, preferably with saturated, aliphatic C₁₄ to C₃₂ monocarboxylic acids and optionally hydroxy monocarboxylic acids.

The commercially obtainable fatty acid esters, in particular of pentaerythritol and glycerol, may contain <60% of various partial esters due to their manufacturing process.

Saturated, aliphatic monocarboxylic acids having 10 to 36 C atoms are for example decanoic acid, dodecanoic acid, tetradecanoic acid, hexadecanoic acid, stearic acid, hydroxystearic acid, eicosanoic acid, docosanoic acid, tetracosanoic acid, hexacosanoic acid and octacosanoic acids.

Preferred saturated, aliphatic monocarboxylic acids having 14 to 22 C atoms are for example tetradecanoic acid, hexadecanoic acid, stearic acid, hydroxystearic acid, eicosanoic acid and docosanoic acid.

Saturated, aliphatic monocarboxylic acids such as hexadecanoic acid, stearic acid and hydroxystearic acid are particularly preferred.

The saturated aliphatic C₁₀ to C₃₆ carboxylic acids and the fatty acid esters are either known per se from the literature or may be produced by methods known from the literature. Examples of pentaerythritol fatty acid esters are those of the particularly preferred monocarboxylic acids specified above.

Esters of pentaerythritol and of glycerol with stearic acid and hexadecanoic acid are particularly preferred.

Esters of guerbet alcohols and of glycerol with stearic acid and hexadecanoic acid and optionally with hydroxystearic acid are also particularly preferred.

Examples of suitable antistatics are cation-active compounds, for example quaternary ammonium, phosphonium or sulfonium salts, anion-active compounds, for example alkyl sulfonates, alkyl sulfates, alkyl phosphates, carboxylates in the form of alkali or alkaline-earth metal salts, non-ionogenic compounds, for example polyethylene glycol esters, polyethylene glycol ethers, fatty acid esters, ethoxylated fatty amines. Preferred antistatics are non-ionogenic compounds.

Suitable UV absorbers are, for example
a) Benzotriazole Derivatives According to Formula (I):

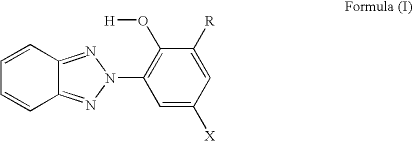

In formula (I) R and X are the same or different and denote H or alkyl or alkylaryl.

Preference is given here to Tinuvin 329 with X=1,1,3,3-tetramethylbutyl and R═H
Tinuvin 350 with X=tert-butyl and R=2-butyl
Tinuvin 234 with X═R=1,1-dimethyl-1-phenyl
   b) Dimeric Benzotriazole Derivatives According to Formula (II):

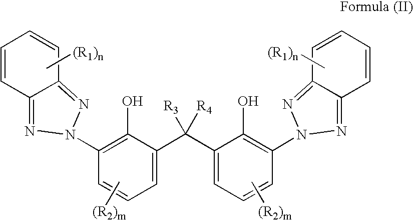

In formula (II) R¹ and R² are the same or different and denote H, halogen, C₁-C₁₀ alkyl, C₅-C₁₀ cycloalkyl, C₇-C₁₃ aralkyl, C₆-C₁₄ aryl, —OR⁵ or —(CO)—O—R⁵ with R⁵ =H or C₁-C₄ alkyl.

In formula (II) R³ and R⁴ are likewise the same or different and denote H, C₁-C₄ alkyl, C₅-C₆ cycloalkyl, benzyl or C₆-C₁₄ aryl.

In formula (II) m denotes 1, 2 or 3 and n 1, 2, 3 or 4.

Preference is given here to Tinuvin 360 with R¹=R³=R⁴=H; n=4; R²=1,1,3,3-tetramethylbutyl; m=1
b1) Dimeric Benzotriazole Derivatives According to Formula (III): 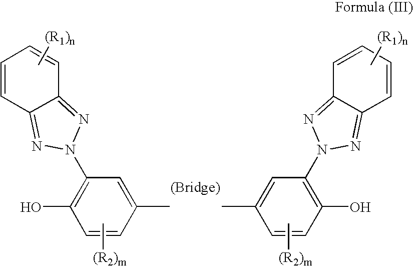
wherein the bridge denotes 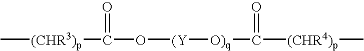
R¹, R², m and n have the meaning cited for formula (II) and wherein p is a whole number from 0 to 3,
q is a whole number from 1 to 10,
Y is equal to —CH₂—CH₂—, —(CH₂)₃—, —(CH₂)₄—, —(CH₂)₅—, —(CH₂)₆—, or CH(CH₃)—CH₂—and
R³ and R⁴ have the meaning cited for formula (II).

Preference is given here to Tinuvin 840 with R¹=H; n=4; R²=tert-butyl; m=1; R² is located ortho to the OH group; R³=R⁴=H; p=2; Y=—(CH₂)₅—; q=1
c) Triazine Derivatives According to Formula (IV): 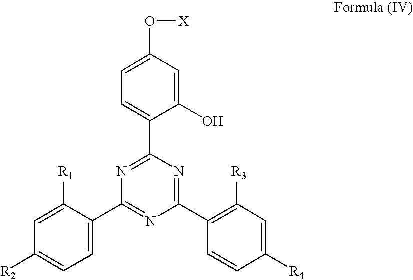
wherein R¹, R², R³, R⁴ in formula (IV) are the same or different and are H or aryl or alkyl or CN or halogen and X is equal to alkyl.

Preference is given here to Tinuvin 1577 with R¹=R²=R³=R⁴=H; X=hexyl and to

Cyasorb UV-1164 with R¹=R²=R³=R⁴=methyl; X=octyl
d) Triazine Derivatives Having the Following Formula (IVa) 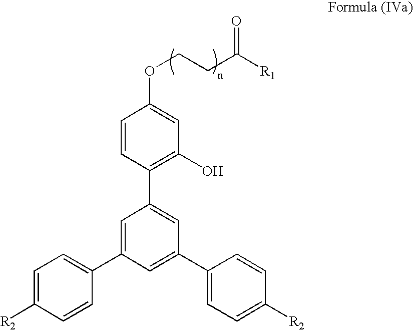
wherein
R¹ denotes C₁ alkyl to C₁₇ alkyl,
R² denotes H or C₁ alkyl to C₄ alkyl and
n is equal to 0 to 20.
e) Dimeric triazine derivatives having the formula (V): 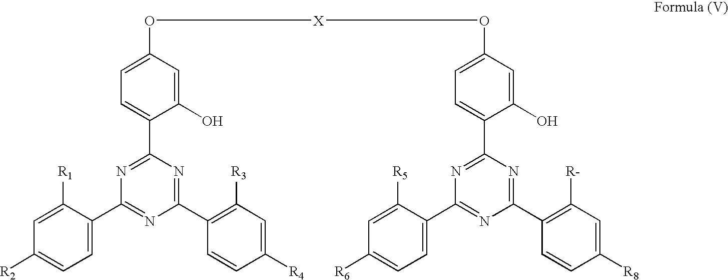
   wherein
   R¹, R², R³, R⁴, R⁵, R⁶, R⁷, R⁸ in formula (V) may be the same or different and denote H or alkyl or CN or halogen and
   X is equal to alkyl or —(CH₂CH₂—O—)ₙ—C(═O)—.
      f) Diaryl Cyanoacrylates Having the Formula (VI): 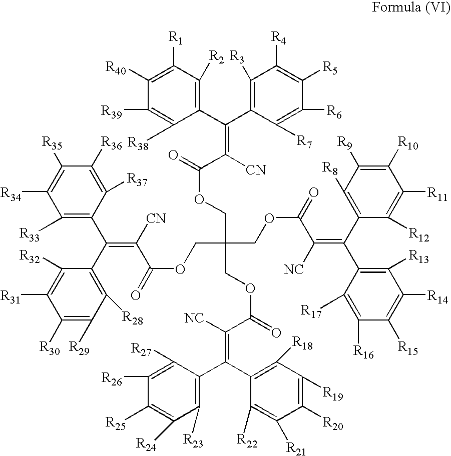
      wherein R¹ to R⁴⁰ may be the same or different and denote H, alkyl, CN or halogen.

Preference is given here to Uvinul 3030 with R¹ to R⁴⁰=H.

The above UV absorbers are generally known to the person skilled in the art and in some cases are commercially available or can be prepared according to processes known to the skilled artisan.

The examples below are intended to illustrate the invention without limiting its scope.

### EXAMPLES

The 2 mm solid sheets listed in examples 1 to 6 were produced as follows:
1. Production of the compound in conventional twin-screw compounding extruders (ZSK 2) at 250 to 330° C.
2. The conventional machines and equipment used to produce the optionally coextruded 2 mm solid sheets comprise:
   the main extruder with a screw of length 33 D and a diameter of 70 mm with venting
   a coextruder for applying the top layer having a screw of length 25 D and a diameter of 35 mm
   a special coextrusion slit die of width 450 mm
   a smoothing calender
   a gravity-roller conveyor
   a take-off unit
   a flying knife (saw)
   a stacking table.

The polycarbonate granules of the base material were fed to the hopper of the main extruder. Melting and conveying of the material took place in the cylinder/screw plasticizing system. The other devices served to transport, cut to length and stack the extruded sheets.

The following polycarbonate grades were used for the examples described below:

Makrolon® 3100 (a homopolycarbonate based on BPA, Mw approx. 32,000, degree of light transmission according to DIN 5036-1 at 4 mm=89.8%, yellowness index according to ASTM E313=1.94) a product of Bayer MaterialScience.

Makrolon® 2800 (a homopolycarbonate based on BPA, Mw approx. 29,000, degree of light transmission according to DIN 5036-1 at 4 mm=89.8%, yellowness index according to ASTM E313=1.65) a product of Bayer Material Science.

Makrolon CD 2005® (a homopolycarbonate based on BPA, Mw approx. 19,000, degree of light transmission according to DIN 5036-1 at 4 mm =89.8%, yellowness index according to ASTM E313=1.19) a product of Bayer MaterialScience.

### Exammple 1

A compound having the following composition was produced:

Makrolon 3100 polycarbonate in a proportion of 97.5 wt. %

Core-shell particles with a butadiene/styrene core and a methyl methacrylate shell Paraloid EXL 5137 from Rohm & Haas with a particle size of 2 to 15 μm and an average particle size of 8 μm in a proportion of 2.4 wt. %.

Heat-stabilized triphenyl phosphine in a proportion of 0.1 wt. %.

A 2 mm solid sheet was extruded from this compound with no coextruded layer.

### Example 2

A compound having the following composition was produced:

Makrolon 3100 polycarbonate in a proportion of 96.9 wt. %

Core-shell particles with a butadiene/styrene core and a methyl methacrylate shell Paraloid EXL 5137 from Rohm & Haas with a particle size of 2 to 15 μm and an average particle size of 8 μm in a proportion of 3.0 wt. %.

Heat-stabilized triphenyl phosphine in a proportion of 0.1 wt. %.

A 2 mm solid sheet was extruded from this compound with no coextruded layer.

### Example 3

A compound having the following composition was produced:

Makrolon 2800 polycarbonate in a proportion of 97.5 wt. %

Core-shell particles with a butadiene/styrene core and a methyl methacrylate shell Paraloid EXL 5137 from Rohm & Haas with a particle size of 2 to 15 μm and an average particle size of 8 μm in a proportion of 2.4 wt. %.

Heat-stabilized triphenyl phosphine in a proportion of 0.1 wt. %.

A 2 mm solid sheet was extruded from this compound with no coextruded layer.

### Example 4

A compound having the following composition was produced:

Makrolon 3100 polycarbonate in a proportion of 96.9 wt. %

Core-shell particles with a butadiene/styrene core and a methyl methacrylate shell Paraloid EXL 5137 from Rohm & Haas with a particle size of 2 to 15 μm and an average particle size of 8 μm in a proportion of 3.0 wt. %.

Heat-stabilized triphenyl phosphine in a proportion of 0.1 wt. %.

A 2 mm solid sheet was extruded from this compound with no coextruded layer.

### Example 5 (according to the invention)

A compound having the following composition was produced:

Makrolon CD 2005 polycarbonate in a proportion of 97.5 wt. %

Core-shell particles with a butadiene/styrene core and a methyl methacrylate shell Paraloid EXL 5137 from Rohm & Haas with a particle size of 2 to 15 μm and an average particle size of 8 μm in a proportion of 2.4 wt. %.

Heat-stabilized triphenyl phosphine in a proportion of 0.1 wt. %.

A 2 mm solid sheet was extruded from this compound with no coextruded layer.

### Example 6 (according to the invention)

A compound having the following composition was produced:

Makrolon CD 2005 polycarbonate in a proportion of 96.9 wt. %

Core-shell particles with a butadiene/styrene core and a methyl methacrylate shell Paraloid EXL 5137 from Rohm & Haas with a particle size of 2 to 15 μm and an average particle size of 8 μm in a proportion of 3.0 wt. %.

Heat-stabilized triphenyl phosphine in a proportion of 0.1 wt. %.

A 2 mm solid sheet was extruded from this compound with no coextruded layer. The 2 mm solid sheets cited in Examples 1 to 6 were assessed for their optical properties in accordance with the following standards and with the following measuring instruments:

An Ultra Scan XE from Hunter Associates Laboratory, Inc. was used to determine the light transmission (Ty (D6510°)) and the light reflection (Ry (D6510°) over a white background). The measurements to determine the yellowness index (Y1(D65, C2°), ASTM E313), the x,y color values (D65, C2°, CIE chromaticity diagram) and the L, a, b color values (D65, C2°, CIELAB color system, DIN 6174) were also performed with this instrument. A Byk-Gardner Hazegard Plus was used for the Haze determination (according to ASTM D 1003). The luminance measurements (brightness measurements) were determined on a backlight unit (BLU) from DS LCD (LTA170WP, 17″ LCD TV panel) with the aid of a Minolta luminance meter LS 100. For this purpose the standard diffuser 5 sheet was removed and replaced by the various 2 mm solid sheets produced in Examples 1 to 6. The BLU comprises four film, and is assembled take as light source-diffuser sheet-films (circular polarizer, diffuser film, prism film BEF, linear polarizer), LCD-display.

The results of the measurements are summarised in Table 1 below.

TABLE 1
Optical data for the 2 mm solid sheets

| | Ex. 1 | Ex. 2 | Ex. 3 | Ex. 4 | Ex. 5 | Ex. 6 |
|---|---|---|---|---|---|---|
| Ty[%](C2°) | 56.39 | 56.21 | 58.38 | 55.10 | 58.94 | 59.04 |
| Hunter | | | | | | |
| Ultra Scan | | | | | | |
| Ry[%](C2°) | 82.75 | 85.06 | 85.77 | 85.55 | 80.83 | 79.47 |
| Hunter | | | | | | |
| Ultra Scan | | | | | | |
| Y1(C2°) | −13.24 | −5.72 | −16.66 | −7.46 | −0.55 | −9.70 |
| L*(C2°) | 79.84 | 79.73 | 80.95 | 79.10 | 81.26 | 81.31 |
| A*(C2°) | −1.11 | −1.71 | −0.74 | −1.42 | 0.78 | −1.25 |
| B*(C2°) | −5.29 | −1.85 | −6.93 | −2.69 | −0.56 | −3.81 |
| Haze[%] | 100 | 100 | 100 | 100 | 100 | 100 |
| Brightness | 5550 | 5550 | 5600 | 5500 | 5550 | 5550 |
| [cd/m2] | | | | | | |
| without | | | | | | |
| films | | | | | | |
| Brightness | 5700 | 5800 | 6000 | 5800 | 6700 | 6750 |
| [cd/m2] | | | | | | |
| with films | | | | | | |

Examples 1 to 6 describe sheets consisting of base resins of differing viscosity but the same additive composition, which exhibit a clear dependence on the viscosity of the base resin in their performance when used as diffuser sheets in backlight units.

The optical properties or light transmission according to DIN 5036-1 at 4 mm are more or less the same for the three polycarbonate viscosities used, with Ty=89.8 to 89.9%. Thus in examples 1 and 2 a polycarbonate having a high molecular weight is used (Makrolon 3100), with a scattering additive content of 2.4 and 3.0 wt. % respectively. What is striking here is that the decisive brightness value is independent of the amount of scattering additive. The brightness in the forward direction is increased by applying the film system. See hereby table 1, ultimate and penultimate line. The differences between example 1 and 3 lie within the range of measuring accuracy of the luminance determination.

In Examples 3 and 4 the only difference from examples 1 and 2 is the base material used, Makrolon 2800 in these examples. The optical properties of the base material are the same as those of Makrolon 3100 and the luminance measurements for Examples 3 and 4 likewise give the same values as in examples 1 and 2.

The luminance values measured in Examples 5 and 6 are surprising, however. Although the luminance values without the set of films are initially still the same as in the previous examples, the clear jump in luminance when the set of films is used, in other words in the final BLU, is surprising here. The luminance values here are about 15 to 18% above the previous examples, which could not have been anticipated given the identical optical data for the CD 2005 base material which was used.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. Solid sheet comprising 80 to 99.99 wt. % of a transparent polycarbonate having weight average molecular weight of 15,000 to 21,000 g/mol , specifically excluding 18,000 g/mol, and 0.01 to 20 wt. % of transparent polymeric particles having an refractive index which differs from that of the polycarbonate.

2. The solid sheet of claim 1 wherein the molecular weight is 18,500 to 20,000 g/mol.

3. The solid sheet of claim 1 wherein the transparent polymeric particles comprise acrylate and have core-shell morphology with a particle size of 1 to 100 μm.

4. The solid sheet of claim 1 further comprising at least one coextruded layer.

5. The solid sheet of claim 4 wherein the coextruded layer contains a UV absorber.

6. The solid sheet of claim 4 wherein the coextruded layer contains a lubricant.

7. The solid sheet of claim 1 further comprising a coextruded layer on each of its sides.

8. The solid sheet of claim 4 wherein the coextruded layer has a thickness of 10 to 100 μm.

9. The solid sheet of claim 7 wherein each of the coextruded layers has a thickness of 10 to 100 μm.

10. The solid sheet of claim 1, characterized in that its thickness is 0.1 to 4.0 mm.

11. A diffuser sheet in a flat screen comprising the sheet of claim 1.

12. The solid sheet of claim 1 wherein the percent transmittance is under 70%.

13. The solid sheet of claim 1 wherein the polymeric particle is organic.

14. The solid sheet of claim 1 wherein the molecular weight is between 15,000 and 18,000 g/mol.
